(19) United States
(12) Patent Application Publication
(10) Pub. No.: US 2009/0044018 A1
(43) Pub. Date: Feb. 12, 2009

(54) Section Inclusion and Section Order Authentication Method for Computer Electronic Documents

(76) Inventors: Mark Louis Kirchner, Phoenix, AZ (US); Scott Idler, Las Cruces, NM (US); David McClosky, Altoona, PA (US)

Correspondence Address: Mark Louis Kirchner, 5101 N. 10th Place, Phoenix, AZ, 85014-3223, US

(21) Appl. No.: 11/835,980

(22) Filed: Aug. 8, 2007

(51) Int. Cl. G06F 7/10

(52) U.S. Cl. 713/176

(57) ABSTRACT

This invention creates an electronic “document authentication chain” providing authentication capability of certain document characteristics. Certain operational scenarios require that a primary or third party can prove the section inclusion and section “inclusion order” of document entries. A minimally intrusive and chained watermarking technique is invented facilitating the authentication of these document characteristics using asymmetric or symmetric key digital signatures.

### CROSS-REFERENCE TO RELATED APPLICATIONS

Not Applicable

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISC APPENDIX

Not Applicable

### BACKGROUND OF THE INVENTION

The present invention relates to computer electronic documents comprised of multiple sections, in particular the characteristics of section inclusion and “inclusion order” and the authentication of these characteristics in an incremental nature.

U.S. Patent Documents

| U.S. Pat. No. | Date Issued | Inventor(s) |
|---|---|---|
| 7,194,636 | Mar. 20, 2007 | Harrison |
| 7,191,156 | Mar. 13, 2007 | Seder |
| 7,162,635 | Jan. 9, 2007 | Bisbee, et al. |
| 7,100,045 | Aug. 29, 2006 | Yamada, et al. |
| 7,069,443 | Jun. 27, 2006 | Berringer, et al. |
| 7,065,650 | Jun. 20, 2006 | Collins, et al. |
| 6,796,489 | Sep. 28, 2004 | Slater, et al. |
| 6,418,457 | Jul. 9, 2002 | Schmidt, et al. |
| 6,327,656 | Dec. 4, 2001 | Zabetian |
| 6,311,271 | Oct. 30, 2001 | Gennaro, et al. |
| 6,085,322 | Jul. 4, 2000 | Romney, et al. |
| 6,021,491 | Feb. 1, 2000 | Renaud |
| 5,958,051 | Sep. 28, 1999 | Renaud, et al. |
| 5,872,848 | Feb. 16, 1999 | Romney, et al. |
| 5,754,659 | May 19, 1998 | Sprunk, et al. |

U.S. Pat. No. 5,754,659 defines a method which produces a separate hash key for each information group without introducing information from the previous information group into the information group. Then a combined hash key is produced of the information group hash keys. A digital signature is computed from the combined hash key allowing means of authentication of the set of hash keys. There is no means defined of incorporating hash key information into the next information group then computing a hash key of the information group and previous hash key.

U.S. Pat. No. 6,327,656 put forth methods which are to be used by a server dependent on the type of certification request received from a client. The process and methods described in U.S. Pat. No. 6,327,656 do not provide any mechanism to inherently support authentication of section inclusion and inclusion order. U.S. Pat. No. 6,327,656 provide methods for independent third part authentication of document with a digital signature, a unique serial number, and time and date information. These methods allow other third parties to have the server third party verify and certify a document as being original.

U.S. Pat. No. 7,100,045 puts forth a method in which date information and a digital signature supplied by a third party produced from the first party document to create a third party digital signature to use as a certification and authentication of the first party document. This method does not use a watermark method which provides authentication of section inclusion and inclusion order.

U.S. Pat. No. 7,191,156 puts forth a method using a client/server architecture in which the signing of data uses steganographic to encode digital signature information from a message sent to a remote computer which is used to authenticate the transmitted document. There is no provision in this method to authenticate document inclusion and inclusion order of separate documents in a sequence of documents.

U.S. Pat. No. 7,162,635 define methods for a system which provides verifiable chain of evidence and security for the retrieval of documents and other information objects. These methods do not use a watermark which authenticates section inclusion and inclusion order.

U.S. Pat. No. 7,194,636 defines a method which provides the use of digital signature to authenticate that data content or document and the digital signature of the storage device used to store said document and then being able to authenticate that said document is on the approved storage device. There is no provision for authentication of document section inclusion or inclusion order utilizing a watermark.

U.S. Pat. No. 6,021,491 defines a method to prove document file inclusion by generating digital signatures for each file of a file set placing these digital signatures into a signature file. The signature file then has a digital signature generated for it to verify its authenticity. File inclusion is validated by the mere fact that its digital signature is placed in the signature file. There is no mechanism defined for which to authenticate file inclusion order in this method. There is no provision for authentication of document section inclusion or inclusion order utilizing a watermark.

U.S. Pat. No. 6,796,489 describe a method for reconstruction of a previous state of a document and then using a digital signature to verify that the reconstruction was correct. This method also provides a method to record an electronic document with a recording third party using digital signatures. There is no provision for authentication of document section inclusion or inclusion order utilizing a watermark.

U.S. Pat. No. 6,311,271 describe a method in which a stream of digital data is divided into original blocks and ancillary information is added to each of the blocks. A signature of not all combined but one or more of the combined blocks is computed and divided into parts to be embedded as part of the ancillary information in each of the blocks transmitted. There is no digital signature of each individual original block including a watermark from the previous block. The method of determining section inclusion and inclusion order is different than the method of the current invention because it does not include a watermark in each block. It also does not compute a digital signature of each block.

U.S. Pat. No. 5,958,051 define methods which utilizes a separate signature file including digital signatures from separate files to be authenticated. All files are treated as independent documents and are not considered as part of a single document chain even though they maybe. Each file has a separate digital signature which is not dependent on the results of the signature of the previous file included in the signature file. The mechanism for determining file inclusion and inclusion order would be simply the order in the signature file and is not dependent on information from a watermark of the previous file in the signature file.

U.S. Pat. No. 7,065,650 defines methods verifying the integrity of a collection of digital objects by computing a hash value for each object then placing these hash values of each object into a hash file and computing a digital signature of the hash file. Digital object inclusion and inclusion order are determined by the order of hashes placed in the hash file. There is no watermark used from the previous digital object in the computation of the current digital object.

U.S. Pat. No. 6,418,457 defines an application to create a system of digitally signed documents including a document creator, an inventor's digital signature with a time stamp, and a witness's digital signature with time stamp of the inventor's document. This system does not use a watermark from the previous document in the computation of the current document's digital signature. This method does not provide a mechanism to authenticate document inclusion of in a particular inventor's notebook except perhaps by using a title of the document or a notebook title embedded in the document. This method also defines a set of user groups for administration, inventor, and witness roles. There is no watermark used to authenticate document inclusion and inclusion order in this method.

U.S. Pat. Nos. 6,085,322 and 5,872,848 defines a method for an originating party and a verifying party to digitally sign a single document in such a way that the authenticity of the document can be verified. Since this is a method for signing single documents it does not include a watermark from previous documents and has no provision for authenticating document inclusion or inclusion order in a document authentication chain.

U.S. Pat. No. 7,069,443 define a method to apply multiple digital signatures to a single electronic document and then also computing a digital signature of the signatures. This method is described to be used on a single electronic document and therefore does not use a watermark from a previous document in the digital signature computations of the current document. There is also no provision from authenticating document inclusion or inclusion order.

### BRIEF SUMMARY OF THE INVENTION

The concept of a “document” used here relates to what is commonly known as a computer electronic document which is contained in one or more computer files. Document used here also represents any computer file(s) containing digital information which is binary information.

For some legal and operational scenarios it is important to be able to validate 1) the order in which a document has been created or modified, 2) what was previously part of the document has not been changed, 3) the set of sections or files making up the document are in fact part of the document, and 4) it may also be important to determine the original document author. This set of characteristics of a document is the document characteristics and the validation of these characteristics shall be the document authentication for the purposes of this invention. The author characteristic is an optional document characteristic and not necessary to authenticate characteristics 1, 2, and 3 above.

It is important that document authentication be capable of being carried out by a third party such that the third party can determine the validity of the document characteristics. Asymmetric key digital signature is used to provide the third party authentication capability. Secret key digital signature would be just as effective for authentication.

“Section(s)” of a document for the purpose of this invention shall refer to either a separate file or an appended record to the end of a file. A document could therefore be comprised of a single file or multiple files. Often electronic documents are created in multiple parts as a result of separate editing sessions. For a single file the results of an editing session can be appended too the end of the file without modifying the previous data of the document. The appended record then represents an added section to the document. Documents in which each creation/editing session results in data representing a section may also be keep in a separate file. This separate file storage format results in multiple files making up the document. This invention provides a method to irrefutably authenticate the document characteristics of document creation scenarios using either of these storage formats. The process of adding a section to a document is referred to as section commitment. A document comprising multiple committed sections is referred to as the “document authentication chain” or “authentication chain”.

A section would be first created in some form of a word and/or graphic processing application resulting in a file containing binary information. Once a document section is complete it then is committed to the document authentication chain. Authentication chain commitment requires, in this order, the inclusion of a watermark from the previous section into the pre-committed section, the computation of a message digest (MD) of the section and watermark, and then the digital signing of section/watermark MD by a third party.

Proof of section inclusion or modification of a document is particularly important. It is also important to authenticate section inclusion before a document is complete. The document inclusion characteristic supported by the authentication chain is an incremental characteristic of the document being built. So all sections currently making up the document must be authentication capable at anytime. When a new section is added it must then be committed to the authentication chain becoming irrefutably part of the document and the commitment does not disturb the authentication chain prior to the new section. This invention is a method by which sections can be shown to be incrementally part of a particular document using a watermark from the previous section. A third party is then able to prove that sections of a document are in fact part of that target document providing authentication for scenarios that require this type of evidence.

Document section inclusion order represents the order of creation and modification of the document. This invention provides a method for third party authentication of the sequence of section inclusion using Digital Signature methods. With our invention it is possible to authenticate the order that sections have been added without using a date and time. However, most legal and operational scenarios for other reasons are best supported when a date and time have been affixed to each section.

Validation that prior sections have not changed once a new section has been added is accomplished by the watermark that is carried forward from the prior section to the new section. If any prior section is changed then that section and the subsequent sections will not authenticate using the third party signature.

Authorship can be included by placing the author's signature of the MD of the first document section, the header, as a data member of the first section. The author's signature is only required to be part of the header. The author's signature is also not required to authenticate section inclusion, section inclusion order, and section modification detection. By not requiring the author to apply a digital signature to each section, the document authentication chain application must provide adequate author authentication capability. If there is no author authentication then the author must apply a digital signature to each section of the document.

Document authentication chains do not require support directly from either word processing or graphic processing applications. The creation of document authentication chains can be supported by a stand alone application which would take data files from any application and then add them to a document authentication chain. The inventors have built a document authentication chain demonstration application utilizing the computing and software development resources of the University of Advancing Technology. This demonstration application successfully creates the described authentication chain capable of including documents or files from any other application. Examples of three applications which would utilize this invention include an electronic engineering notebook, medical records, and legal records.

### BRIEF DESCRIPTION OF THE DRAWINGS

FIGS. 1, 2 and 3 are logical pseudo code schematic representations of a typical hierarchical data structure required to implement a document authentication chain

FIG. 1, “Minimum Document Header Section”, is a schematic of the authentication chain header data structure showing the nesting of information.

FIG. 2, “Document Header Section with Authentication of Authorship”, is a schematic of the authentication chain header data structure showing the nesting of information and providing authorship authentication.

FIG. 3, “Section Data Structure”, is a schematic of the authentication chain section inclusion data.

### DETAILED DESCRIPTION OF THE INVENTION

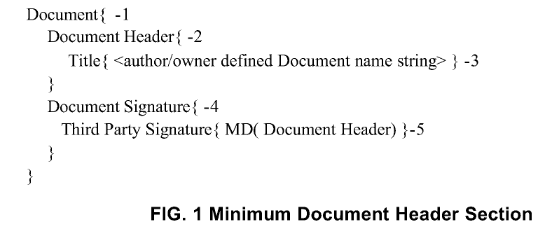

Referring to FIG. 1, A Document 1 comprised of a Document Header 2 which includes a document Title 3 defined by an author/owner. The message digest (MD) is a function that computes a message digest of the input parameter data. The MD of the Document Header 2 is sent to a third party to compute and return a Third Party Signature 5 of the Document Header 2 including the Title 3. This digital signature becomes known as the Document Signature 4. FIG. 1 shows this Document Header 2 in a form which would provide authentication of all document characteristics except that of the document's original author.

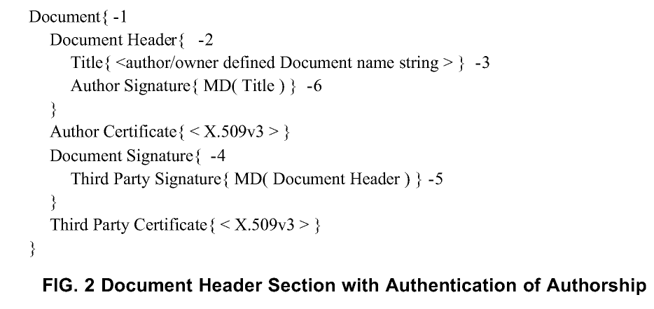

Referring to FIG. 2, which illustrates a Document 1 with Document Header 2 which supports the authentication of the author's ownership. A digital signature of the Title 3 MD is computed by the author/owner using the author's private key with local resources and is the Author Signature 6. Author/owner for this invention refers to the entity that created the document authentication chain. The MD of Document Header 2 is sent to the third party for a Third Party Signature 5 and becomes the Document Signature 4. The author can be authenticated as the author of this document using the Author Signature 6. The information contained in the Author Signature 6 is incorporated in the Document Signature 5.

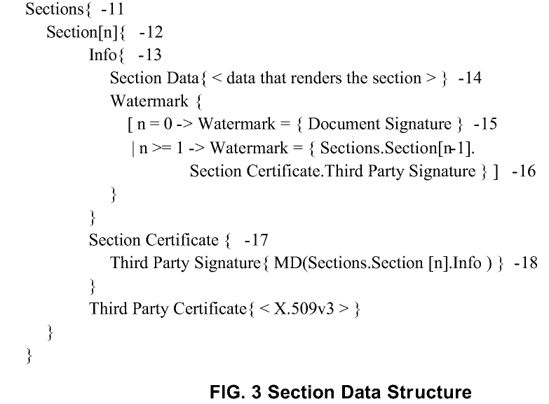

Referring to FIG. 3, after the Document 1 FIG. 1 or FIG. 2 come the Sections 11 added after subsequent editing sessions are completed and a Section 12 is committed to the authentication chain. Each subsequent Section 12 Info 13 is comprised of the Section Data 14 making up the document, a Watermark 15 or 16 from the previous section, and a Section Certificate 17. Section Data 14 may be the actual rendering data or it could be a named reference to a file which contains the rendering data. If the previous section is the Document 1 FIG. 1 or FIG. 2 then the Document Signature 9 FIG. 2 or FIG. 1 is used as the Watermark 15. If the current section is n then the previous section is n−1. The Watermark 16 for Section 12, n, is the previous Section's 12, n−1, Section Certificate 17. The Section Certificate 17 is computed by sending the MD of the Info 13 member of the Section 12 to the Third Party for a digital signature producing a Third Party Signature 18.

Carrying the Document Signature 4 FIG. 2 or Section Certificate 17 FIG. 3 as the Watermark 15 or 16 FIG. 3 forward from the previous section supports the authentication of the document characteristics including section inclusion, section inclusion order, and the authorship characteristics. Each subsequent section is dependent on the previous section's Watermark 15 or 16 FIG. 3. If a Section 12 has been changed then subsequent Sections 12 will not authenticate as a result of not having the appropriate Watermark 15 or 16 FIG. 3 value from the changed Section 12. When the Document Header 2 FIG. 2 has the Author Signature 6 FIG. 2 incorporated then all subsequent document Sections 11 FIG. 3 will have a Watermark 15 or 16 FIG. 3 which has information incorporated in it from the Author Signature 6 FIG. 2. If any of the Section Data 14 FIG. 3 or Watermark 15 or 16 FIG. 3 are not the original set of digital data and Section Certificate 17 FIG. 3, a third party will not get a positive authentication of the Section 12 FIG. 3.

We claim:

1. A method for authenticating document section inclusion and inclusion order comprising:
a computer digital data structure containing a method to reference section data;
a method to create a digital signature of the combined section data and previous section's digital signature data.

2. A method for authenticating document section inclusion and inclusion order comprising:
a computer digital data structure containing a method for unique identification;
a method to create a digital signature of the unique identification;
a subsequent computer digital data structure containing a method to reference section data;
a method to create a digital signature of the combined section data and previous section's digital signature data.
